(19) United States
(12) Patent Application Publication
(10) Pub. No.: US 2016/0078880 A1
(43) Pub. Date: Mar. 17, 2016

(54) Systems and Methods for Restoration of Speech Components

(71) Applicant: Audience, Inc., Mountain View, CA (US)

(72) Inventors: Carlos Avendano, Campbell, CA (US); John Woodruff, Palo Alto, CA (US)

(21) Appl. No.: 14/852,446

(22) Filed: Sep. 11, 2015

Related U.S. Application Data
(60) Provisional application No. 62/049,988, filed on Sep. 12, 2014.

(51) Int. Cl. G10L 21/0232; G10L 25/30

(52) U.S. Cl. CPC G10L 21/0232; G10L 25/30

(57) ABSTRACT

A method for restoring distorted speech components of an audio signal distorted by a noise reduction or a noise cancellation includes determining distorted frequency regions and undistorted frequency regions in the audio signal. The distorted frequency regions include regions of the audio signal in which a speech distortion is present. Iterations are performed using a model to refine predictions of the audio signal at distorted frequency regions. The model is configured to modify the audio signal and may include deep neural network trained using spectral envelopes of clean or undamaged audio signals. Before each iteration, the audio signal at the undistorted frequency regions is restored to values of the audio signal prior to the first iteration; while the audio signal at distorted frequency regions is refined starting from zero at the first iteration. Iterations are ended when discrepancies of audio signal at undistorted frequency regions meet pre-defined criteria.

### CROSS-REFERENCE TO RELATED APPLICATION

The present application claims the benefit of U.S. Provisional Application No. 62/049,988, filed on Sep. 12, 2014. The subject matter of the aforementioned application is incorporated herein by reference for all purposes.

### FIELD

The present application relates generally to audio processing and, more specifically, to systems and methods for restoring distorted speech components of a noise-suppressed audio signal.

### BACKGROUND

Noise reduction is widely used in audio processing systems to suppress or cancel unwanted noise in audio signals used to transmit speech. However, after the noise cancellation and/or suppression, speech that is intertwined with noise tends to be overly attenuated or eliminated altogether in noise reduction systems.

There are models of the brain that explain how sounds are restored using an internal representation that perceptually replaces the input via a feedback mechanism. One exemplary model called a convergence-divergence zone (CDZ) model of the brain has been described in neuroscience and, among other things, attempts to explain the spectral completion and phonemic restoration phenomena found in human speech perception.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Systems and methods for restoring distorted speech components of an audio signal are provided. An example method includes determining distorted frequency regions and undistorted frequency regions in the audio signal. The distorted frequency regions include regions of the audio signal in which a speech distortion is present. The method includes performing one or more iterations using a model for refining predictions of the audio signal at the distorted frequency regions. The model can be configured to modify the audio signal.

In some embodiments, the audio signal includes a noise-suppressed audio signal obtained by at least one of noise reduction or noise cancellation of an acoustic signal including speech. The acoustic signal is attenuated or eliminated at the distorted frequency regions.

In some embodiments, the model used to refine predictions of the audio signal at the distorted frequency regions includes a deep neural network trained using spectral envelopes of clean audio signals or undamaged audio signals. The refined predictions can be used for restoring speech components in the distorted frequency regions.

In some embodiments, the audio signals at the distorted frequency regions are set to zero before the first iteration. Prior to performing each of the iterations, the audio signals at the undistorted frequency regions are restored to initial values before the first iterations.

In some embodiments, the method further includes comparing the audio signal at the undistorted frequency regions before and after each of the iterations to determine discrepancies. In certain embodiments, the method allows ending the one or more iterations if the discrepancies meet pre-determined criteria. The pre-determined criteria can be defined by low and upper bounds of energies of the audio signal.

According to another example embodiment of the present disclosure, the steps of the method for restoring distorted speech components of an audio signal are stored on a non-transitory machine-readable medium comprising instructions, which when implemented by one or more processors perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram illustrating an environment in which the present technology may be practiced.

FIG. 2 is a block diagram illustrating an audio device, according to an example embodiment.

FIG. 3 is a block diagram illustrating modules of an audio processing system, according to an example embodiment.

FIG. 4 is a flow chart illustrating a method for restoration of speech components of an audio signal, according to an example embodiment.

FIG. 5 is a computer system which can be used to implement methods of the present technology, according to an example embodiment.

### DETAILED DESCRIPTION

The technology disclosed herein relates to systems and methods for restoring distorted speech components of an audio signal. Embodiments of the present technology may be practiced with any audio device configured to receive and/or provide audio such as, but not limited to, cellular phones, wearables, phone handsets, headsets, and conferencing systems. It should be understood that while some embodiments of the present technology will be described in reference to operations of a cellular phone, the present technology may be practiced with any audio device.

Audio devices can include radio frequency (RF) receivers, transmitters, and transceivers, wired and/or wireless telecommunications and/or networking devices, amplifiers, audio and/or video players, encoders, decoders, speakers, inputs, outputs, storage devices, and user input devices. The audio devices may include input devices such as buttons, switches, keys, keyboards, trackballs, sliders, touchscreens, one or more microphones, gyroscopes, accelerometers, global positioning system (GPS) receivers, and the like. The audio devices may include output devices, such as LED indicators, video displays, touchscreens, speakers, and the like. In some embodiments, mobile devices include wearables and hand-held devices, such as wired and/or wireless remote controls, notebook computers, tablet computers, phablets, smart phones, personal digital assistants, media players, mobile telephones, and the like.

In various embodiments, the audio devices can be operated in stationary and portable environments. Stationary environments can include residential and commercial buildings or structures, and the like. For example, the stationary embodiments can include living rooms, bedrooms, home theaters, conference rooms, auditoriums, business premises, and the like. Portable environments can include moving vehicles, moving persons, other transportation means, and the like.

According to an example embodiment, a method for restoring distorted speech components of an audio signal includes determining distorted frequency regions and undistorted frequency regions in the audio signal. The distorted frequency regions include regions of the audio signal wherein speech distortion is present. The method includes performing one or more iterations using a model for refining predictions of the audio signal at the distorted frequency regions. The model can be configured to modify the audio signal.

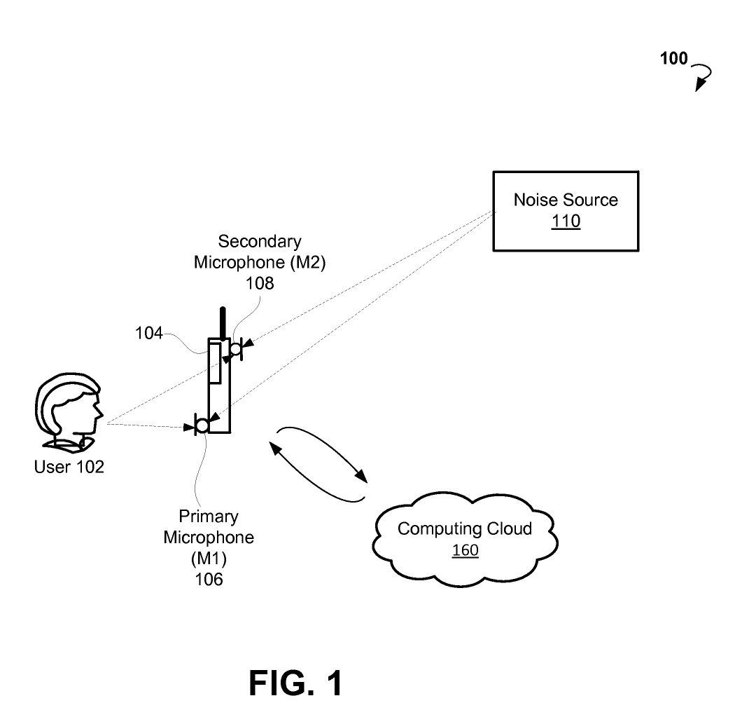

Referring now to FIG. 1, an environment 100 is shown in which a method for restoring distorted speech components of an audio signal can be practiced. The example environment 100 can include an audio device 104 operable at least to receive an audio signal. The audio device 104 is further operable to process and/or record/store the received audio signal.

In some embodiments, the audio device 104 includes one or more acoustic sensors, for example microphones. In example of FIG. 1, audio device 104 includes a primary microphone (M1) 106 and a secondary microphone 108. In various embodiments, the microphones 106 and 108 are used to detect both acoustic audio signal, for example, a verbal communication from a user 102 and a noise 110. The verbal communication can include keywords, speech, singing, and the like.

Noise 110 is unwanted sound present in the environment 100 which can be detected by, for example, sensors such as microphones 106 and 108. In stationary environments, noise sources can include street noise, ambient noise, sounds from a mobile device such as audio, speech from entities other than an intended speaker(s), and the like. Noise 110 may include reverberations and echoes. Mobile environments can encounter certain kinds of noises which arise from their operation and the environments in which they operate, for example, road, track, tire/wheel, fan, wiper blade, engine, exhaust, entertainment system, communications system, competing speakers, wind, rain, waves, other vehicles, exterior, and the like noise. Acoustic signals detected by the microphones 106 and 108 can be used to separate desired speech from the noise 110.

In some embodiments, the audio device 104 is connected to a cloud-based computing resource 160 (also referred to as a computing cloud). In some embodiments, the computing cloud 160 includes one or more server farms/clusters comprising a collection of computer servers and is co-located with network switches and/or routers. The computing cloud 160 is operable to deliver one or more services over a network (e.g., the Internet, mobile phone (cell phone) network, and the like). In certain embodiments, at least partial processing of audio signal is performed remotely in the computing cloud 160. The audio device 104 is operable to send data such as, for example, a recorded acoustic signal, to the computing cloud 160, request computing services and to receive the results of the computation.

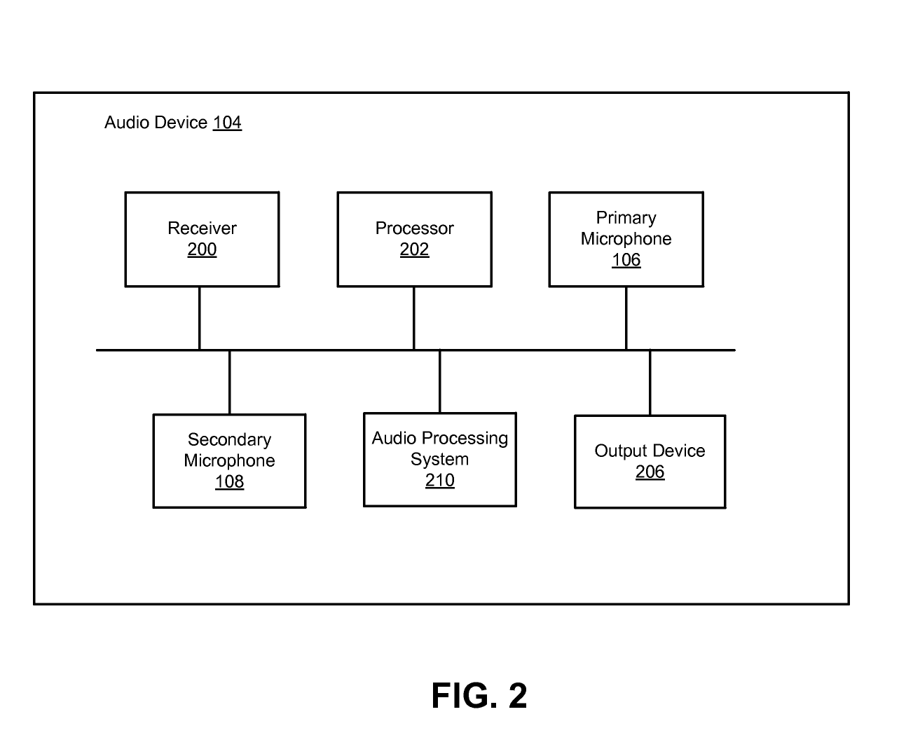

FIG. 2 is a block diagram of an example audio device 104. As shown, the audio device 104 includes a receiver 200, a processor 202, the primary microphone 106, the secondary microphone 108, an audio processing system 210, and an output device 206. The audio device 104 may include further or different components as needed for operation of audio device 104. Similarly, the audio device 104 may include fewer components that perform similar or equivalent functions to those depicted in FIG. 2. For example, the audio device 104 includes a single microphone in some embodiments, and two or more microphones in other embodiments.

In various embodiments, the receiver 200 can be configured to communicate with a network such as the Internet, Wide Area Network (WAN), Local Area Network (LAN), cellular network, and so forth, to receive audio signal. The received audio signal is then forwarded to the audio processing system 210.

In various embodiments, processor 202 includes hardware and/or software, which is operable to execute instructions stored in a memory (not illustrated in FIG. 2). The exemplary processor 202 uses floating point operations, complex operations, and other operations, including noise suppression and restoration of distorted speech components in an audio signal.

The audio processing system 210 can be configured to receive acoustic signals from an acoustic source via at least one microphone (e.g., primary microphone 106 and secondary microphone 108 in the examples in FIG. 1 and FIG. 2) and process the acoustic signal components. The microphones 106 and 108 in the example system are spaced a distance apart such that the acoustic waves impinging on the device from certain directions exhibit different energy levels at the two or more microphones. After reception by the microphones 106 and 108, the acoustic signals can be converted into electric signals. These electric signals can, in turn, be converted by an analog-to-digital converter (not shown) into digital signals for processing in accordance with some embodiments.

In various embodiments, where the microphones 106 and 108 are omni-directional microphones that are closely spaced (e.g., 1-2 cm apart), a beamforming technique can be used to simulate a forward-facing and backward-facing directional microphone response. A level difference can be obtained using the simulated forward-facing and backward-facing directional microphone. The level difference can be used to discriminate speech and noise in, for example, the time-frequency domain, which can be used in noise and/or echo reduction. In some embodiments, some microphones are used mainly to detect speech and other microphones are used mainly to detect noise. In various embodiments, some microphones are used to detect both noise and speech.

The noise reduction can be carried out by the audio processing system 210 based on inter-microphone level differences, level salience, pitch salience, signal type classification, speaker identification, and so forth. In various embodiments, noise reduction includes noise cancellation and/or noise suppression.

In some embodiments, the output device 206 is any device which provides an audio output to a listener (e.g., the acoustic source). For example, the output device 206 may comprise a speaker, a class-D output, an earpiece of a headset, or a handset on the audio device 104.

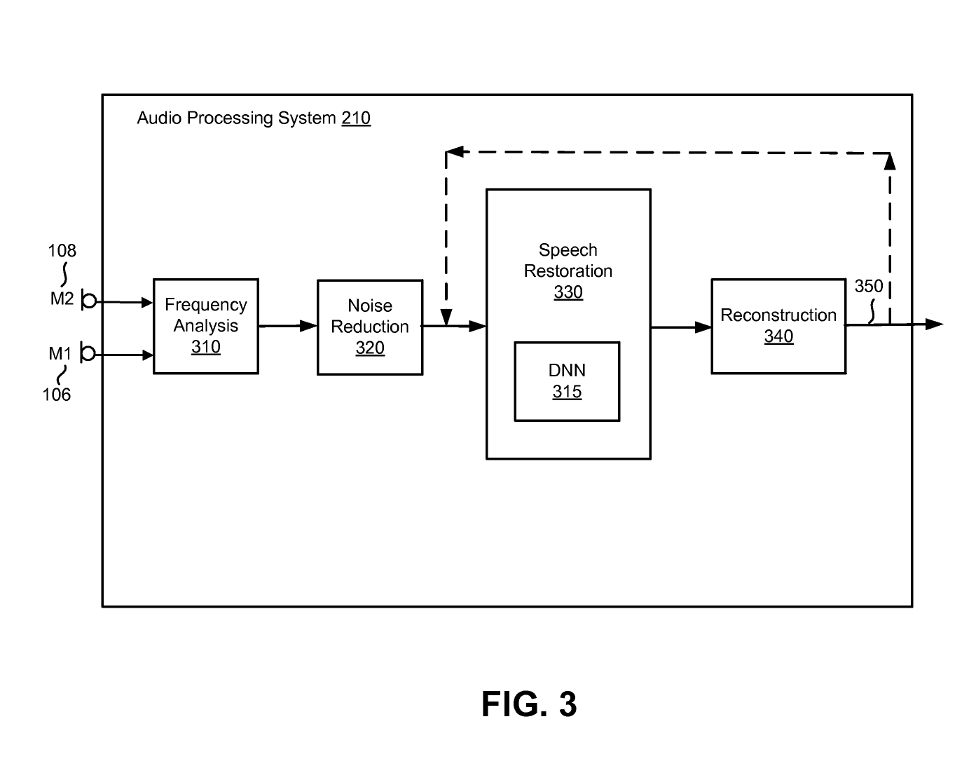

FIG. 3 is a block diagram showing modules of an audio processing system 210, according to an example embodiment. The audio processing system 210 of FIG. 3 may provide more details for the audio processing system 210 of FIG. 2. The audio processing system 210 includes a frequency analysis module 310, a noise reduction module 320, a speech restoration module 330, and a reconstruction module 340. The input signals may be received from the receiver 200 or microphones 106 and 108.

In some embodiments, audio processing system 210 is operable to receive an audio signal including one or more time-domain input audio signals, depicted in the example in FIG. 3 as being from the primary microphone (M1) and secondary microphones (M2) in FIG. 1. The input audio signals are provided to frequency analysis module 310.

In some embodiments, frequency analysis module 310 is operable to receive the input audio signals. The frequency analysis module 310 generates frequency sub-bands from the time-domain input audio signals and outputs the frequency sub-band signals. In some embodiments, the frequency analysis module 310 is operable to calculate or determine speech components, for example, a spectrum envelope and excitations, of received audio signal.

In various embodiments, noise reduction module 320 includes multiple modules and receives the audio signal from the frequency analysis module 310. The noise reduction module 320 is operable to perform noise reduction in the audio signal to produce a noise-suppressed signal. In some embodiments, the noise reduction includes a subtractive noise cancellation or multiplicative noise suppression. By way of example and not limitation, noise reduction methods are described in U.S. patent application Ser. No. 12/215,980, entitled “System and Method for Providing Noise Suppression Utilizing Null Processing Noise Subtraction,” filed Jun. 30, 2008, and in U.S. patent application Ser. No. 11/699,732 (U.S. Pat. No. 8,194,880), entitled “System and Method for Utilizing Omni-Directional Microphones for Speech Enhancement,” filed Jan. 29, 2007, which are incorporated herein by reference in their entireties for the above purposes. The noise reduction module 320 provides a transformed, noise-suppressed signal to speech restoration module 330. In the noise-suppressed signal one or more speech components can be eliminated or excessively attenuated since the noise reduction transforms the frequency of the audio signal.

In some embodiments, the speech restoration module 330 receives the noise-suppressed signal from the noise reduction module 320. The speech restoration module 330 is configured to restore damaged speech components in noise-suppressed signal. In some embodiments, the speech restoration module 330 includes a deep neural network (DNN) 315 trained for restoration of speech components in damaged frequency regions. In certain embodiments, the DNN 315 is configured as an autoencoder.

In various embodiments, the DNN 315 is trained using machine learning. The DNN 315 is a feed-forward, artificial neural network having more than one layer of hidden units between its inputs and outputs. The DNN 315 may be trained by receiving input features of one or more frames of spectral envelopes of clean audio signals or undamaged audio signals. In the training process, the DNN 315 may extract learned higher-order spectro-temporal features of the clean or undamaged spectral envelopes. In various embodiments, the DNN 315, as trained using the spectral envelopes of clean or undamaged envelopes, is used in the speech restoration module 330 to refine predictions of the clean speech components that are particularly suitable for restoring speech components in the distorted frequency regions. By way of example and not limitation, exemplary methods concerning deep neural networks are also described in commonly assigned U.S. patent application Ser. No. 14/614,348, entitled “Noise-Robust Multi-Lingual Keyword Spotting with a Deep Neural Network Based Architecture,” filed Feb. 4, 2015, and U.S. patent application Ser. No. 14/745,176, entitled “Key Click Suppression,” filed Jun. 9, 2015, which are incorporated herein by reference in their entirety.

During operation, speech restoration module 330 can assign a zero value to the frequency regions of noise-suppressed signal where a speech distortion is present (distorted regions). In the example in FIG. 3, the noise-suppressed signal is further provided to the input of DNN 315 to receive an output signal. The output signal includes initial predictions for the distorted regions, which might not be very accurate.

In some embodiments, to improve the initial predictions, an iterative feedback mechanism is further applied. The output signal 350 is optionally fed back to the input of DNN 315 to receive a next iteration of the output signal, keeping the initial noise-suppressed signal at undistorted regions of the output signal. To prevent the system from diverging, the output at the undistorted regions may be compared to the input after each iteration, and upper and lower bounds may be applied to the estimated energy at undistorted frequency regions based on energies in the input audio signal. In various embodiments, several iterations are applied to improve the accuracy of the predictions until a level of accuracy desired for a particular application is met, e.g., having no further iterations in response to discrepancies of the audio signal at undistorted regions meeting pre-defined criteria for the particular application.

In some embodiments, reconstruction module 340 is operable to receive a noise-suppressed signal with restored speech components from the speech restoration module 330 and to reconstruct the restored speech components into a single audio signal.

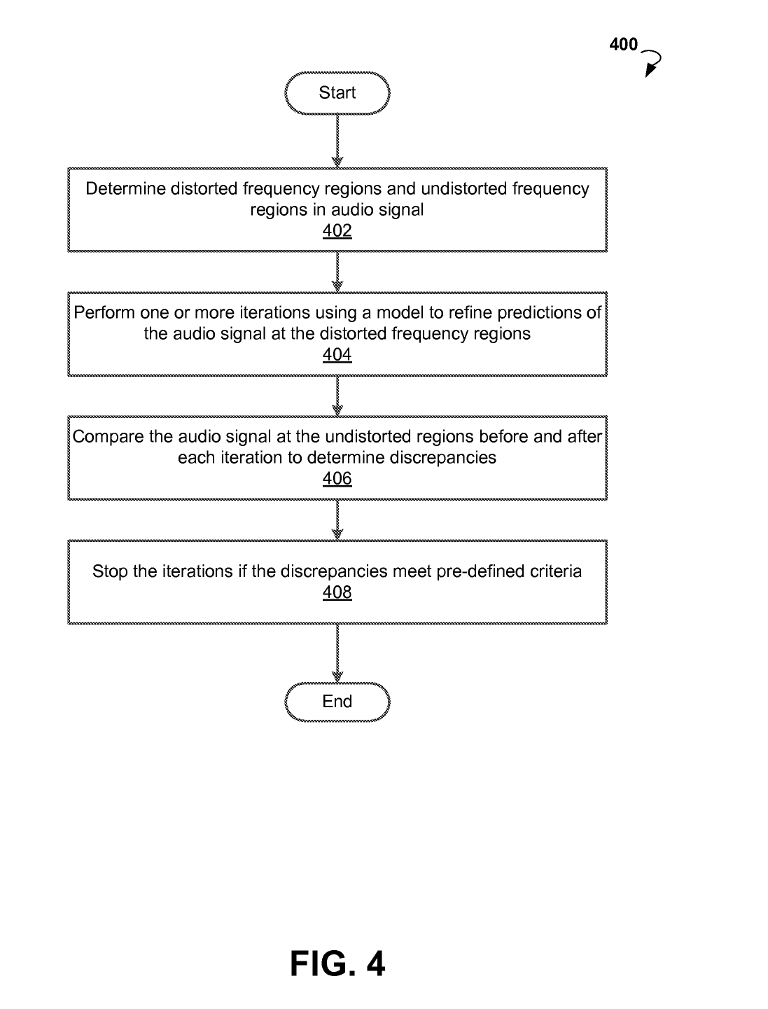

FIG. 4 is flow chart diagram showing a method 400 for restoring distorted speech components of an audio signal, according to an example embodiment. The method 400 can be performed using speech restoration module 330.

The method can commence, in block 402, with determining distorted frequency regions and undistorted frequency regions in the audio signal. The distorted speech regions are regions in which a speech distortion is present due to, for example, noise reduction.

In block 404, method 400 includes performing one or more iterations using a model to refine predictions of the audio signal at distorted frequency regions. The model can be configured to modify the audio signal. In some embodiments, the model includes a deep neural network trained with spectral envelopes of clean or undamaged signals. In certain embodiments, the predictions of the audio signal at distorted frequency regions are set to zero before to the first iteration. Prior to each of the iterations, the audio signal at undistorted frequency regions is restored to values of the audio signal before the first iteration.

In block 406, method 400 includes comparing the audio signal at the undistorted regions before and after each of the iterations to determine discrepancies.

In block 408, the iterations are stopped if the discrepancies meet pre-defined criteria.

Some example embodiments include speech dynamics. For speech dynamics, the audio processing system 210 can be provided with multiple consecutive audio signal frames and trained to output the same number of frames. The inclusion of speech dynamics in some embodiments functions to enforce temporal smoothness and allow restoration of longer distortion regions.

Various embodiments are used to provide improvements for a number of applications such as noise suppression, bandwidth extension, speech coding, and speech synthesis. Additionally, the methods and systems are amenable to sensor fusion such that, in some embodiments, the methods and systems for can be extended to include other non-acoustic sensor information. Exemplary methods concerning sensor fusion are also described in commonly assigned U.S. patent application Ser. No. 14/548,207, entitled “Method for Modeling User Possession of Mobile Device for User Authentication Framework,” filed Nov. 19, 2014, and U.S. patent application Ser. No. 14/331,205, entitled “Selection of System Parameters Based on Non-Acoustic Sensor Information,” filed Jul. 14, 2014, which are incorporated herein by reference in their entirety.

Various methods for restoration of noise reduced speech are also described in commonly assigned U.S. patent application Ser. No. 13/751,907 (U.S. Pat. No. 8,615,394), entitled “Restoration of Noise Reduced Speech,” filed Jan. 28, 2013, which is incorporated herein by reference in its entirety.

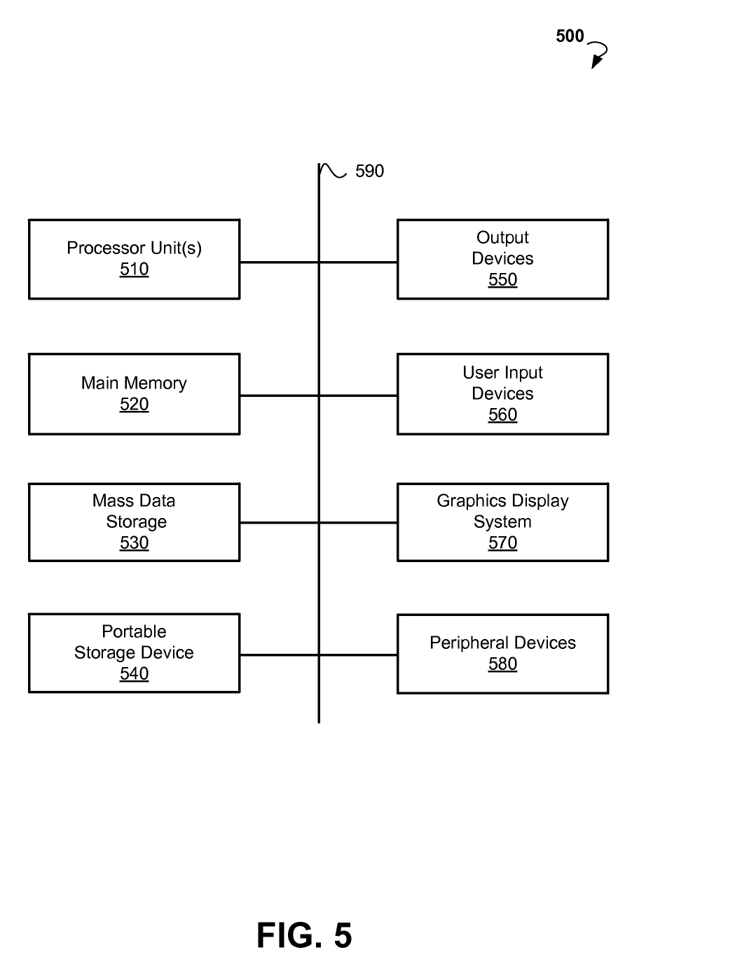

FIG. 5 illustrates an exemplary computer system 500 that may be used to implement some embodiments of the present invention. The computer system 500 of FIG. 5 may be implemented in the contexts of the likes of computing systems, networks, servers, or combinations thereof. The computer system 500 of FIG. 5 includes one or more processor units 510 and main memory 520. Main memory 520 stores, in part, instructions and data for execution by processor units 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580.

The components shown in FIG. 5 are depicted as being connected via a single bus 590. The components may be connected through one or more data transport means.

Processor unit 510 and main memory 520 is connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 include a liquid crystal display (LCD) or other suitable display device. Graphics display system 570 is configurable to receive textual and graphical information and processes the information for output to the display device.

Peripheral devices 580 may include any type of computer support device to add additional functionality to the computer system 500.

The components provided in the computer system 500 of FIG. 5 are those typically found in computer systems that may be suitable for use with embodiments of the present disclosure and are intended to represent a broad category of such computer components that are well known in the art. Thus, the computer system 500 of FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN and other suitable operating systems.

The processing for various embodiments may be implemented in software that is cloud-based. In some embodiments, the computer system 500 is implemented as a cloud-based computing environment, such as a virtual machine operating within a computing cloud. In other embodiments, the computer system 500 may itself include a cloud-based computing environment, where the functionalities of the computer system 500 are executed in a distributed fashion. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 500, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for restoring distorted speech components of an audio signal, the method comprising:
determining distorted frequency regions and undistorted frequency regions in the audio signal, the distorted frequency regions including regions of the audio signal in which speech distortion is present; and
performing one or more iterations using a model to refine predictions of the audio signal at the distorted frequency regions, the model being configured to modify the audio signal.

2. The method of claim 1, wherein the audio signal includes a noise-suppressed audio signal obtained by at least one of a noise reduction or a noise cancellation of an acoustic signal including speech.

3. The method of claim 2, wherein the acoustic signal is attenuated or eliminated at the distorted frequency regions.

4. The method of claim 1, wherein the model includes a deep neural network trained using spectral envelopes of clean audio signals or undamaged audio signals.

5. The method of claim 1, wherein the refined predictions are used for restoring speech components in the distorted frequency regions.

6. The method of claim 1, wherein the audio signal at the distorted frequency regions is set to zero before the first of the one or more iterations.

7. The method of claim 1, wherein prior to performing each of the one or more iterations, the audio signal at the undistorted frequency regions is restored to values of the audio signal before the first of the one or more iterations.

8. The method of claim 1, further comprising after performing each of the one or more iterations comparing the audio signal at the undistorted frequency regions before and after the iteration to determine discrepancies.

9. The method of claim 8, further comprising ending the one or more iterations if the discrepancies meet pre-determined criteria.

10. The method of claim 9, wherein the pre-determined criteria are defined by low and upper bounds of energies of the audio signal.

11. A system for restoring distorted speech components of an audio signal, the system comprising:
at least one processor; and
a memory communicatively coupled with the at least one processor, the memory storing instructions, which when executed by the at least one processor performs a method comprising:
determining distorted frequency regions and undistorted frequency regions in the audio signal, the distorted frequency regions including regions of the audio signal in which speech distortion is present; and
performing one or more iterations using a model to refine predictions of the audio signal at the distorted frequency regions, the model being configured to modify the audio signal.

12. The system of claim 11, wherein the audio signal includes a noise-suppressed audio signal obtained by at least one of a noise reduction or a noise cancellation of an acoustic signal including speech.

13. The system of claim 12, wherein the acoustic signal is attenuated or eliminated at the distorted frequency regions.

14. The system of claim 11, wherein the model includes a deep neural network.

15. The system of claim 14, wherein the deep neural network is trained using spectral envelopes of clean audio signals or undamaged audio signals.

16. The system of claim 15, wherein the audio signal at the distorted frequency regions are set to zero before the first of the one or more iterations.

17. The system of claim 11, wherein before performing each of the one or more iterations, the audio signal at the undistorted frequency regions is restored to values before the first of the one or more iterations.

18. The system of claim 11, further comprising, after performing each of the one or more iterations, comparing the audio signal at the undistorted regions before and after the iteration to determine discrepancies.

19. The system of claim 18, further comprising ending the one or more iterations if the discrepancies meet pre-determined criteria, the pre-determined criteria being defined by low and upper bounds of energies of the audio signal.

20. A non-transitory computer-readable storage medium having embodied thereon instructions, which when executed by at least one processor, perform steps of a method, the method comprising:
determining distorted frequency regions and undistorted frequency regions in the audio signal, the distorted frequency regions including regions of the audio signal wherein speech distortion is present; and
performing one or more iterations using a model to refine predictions of the audio signal at the distorted frequency regions, the model being configured to modify the audio signal.
